(19) United States
(12) Patent Application Publication
(10) Pub. No.: US 2020/0068349 A1
(43) Pub. Date: Feb. 27, 2020

(54) METHOD AND SYSTEM FOR CROWD- SOURCED MAP FEATURE UPDATING

(71) Applicant: MAPSTED CORP., Mississauga (CA)

(72) Inventors: Sean Huberman, Guelph (CA); Eros Gulo, Woodbridge (CA)

(73) Assignee: MAPSTED CORP., Mississauga (CA)

(21) Appl. No.: 16/113,044

(22) Filed: Aug. 27, 2018

(51) Int. Cl. H04W 4/024; H04W 4/33; H04L 29/08; H04W 4/029

(52) U.S. Cl. CPC H04W 4/024; H04W 4/029; H04L 67/18; H04W 4/33

(57) ABSTRACT

A method and system of updating a map feature. The method, executed in a processor of a server computing device, comprises receiving, from a mobile device, a request for update of a map feature, generating a request for localizing the mobile device, validating the request for update based on a threshold confidence level associated with the localizing, and upon the validating, updating the map feature in a memory of the server computing device.

### TECHNICAL FIELD

The disclosure herein relates to the field of mobile device indoor navigation and localization.

### BACKGROUND

Users of mobile devices are increasingly using and depending upon indoor positioning and navigation applications and features. Seamless, accurate and dependable indoor positioning of a mobile device carried or worn by a user can be difficult to achieve using satellite-based navigation systems when the latter becomes unavailable, or only sporadically available and therefore unreliable, such as within enclosed, or partially enclosed, urban infrastructure and buildings, including hospitals, shopping malls, airports, university campuses and industrial warehouses. Updating of indoor layout maps used in indoor navigation, for instance in a shopping mall or airport where the navigation system is deployed to the public, presents a significant challenge in maintaining accuracy and attendant usefulness of the map content presented to mobile device users.

### BRIEF DESCRIPTION OF THE DRAWINGS

FIG. 1 illustrates, in an example embodiment, a server-based system for crowd-sourced updating of a map feature.

FIG. 2 illustrates, in one example embodiment, an architecture of a server computing device in a crowd-sourced system for updating a map feature.

FIG. 3 illustrates an example embodiment method of updating a map feature within a crowd-sourced map updating system.

FIGS. 4A-4C illustrate, in an example embodiment, a map feature update performed in conjunction with a user interface display of a mobile device.

### DETAILED DESCRIPTION

Updating of indoor maps while a system is deployed to the public is a great challenge. Many shopping mall websites are out of date or not regularly maintained. Among other benefits and technical effect, embodiments provided herein allow mobile device users who are located inside the mall or other infrastructure to provide accurate in-app based feedback to assist with map maintenance. While a major concern may be inaccurate information, a validation system is provided to filter the user inputs and maintain only the most likely correct changes. The ability to dynamically allow for user-maintenance ensures a dynamic system whereby manual technician-based map maintenance requirements is drastically reduced by harnessing the power of mobile device user crowdsourcing.

Provided is a method, executed at least partly in a processor of a server computing device, that comprises receiving, from a mobile device, a request for update of a map feature, generating a request for localizing the mobile device, validating the request for update based on a threshold confidence level associated with the localizing, and upon the validating, updating the map feature in a memory of the server computing device.

Also provided is a server computing device for updating a map feature. The server computing device comprises a processor and a memory including instructions executable in the processor to receive, from a mobile device, a request for update of a map feature, generate a request for localizing the mobile device, validate the request for update based on a threshold confidence level associated with the localizing and upon the validating, update the map feature in a memory of the server computing device.

The terms localize, or localization, as used herein refer to determining a unique coordinate position of the mobile device at a specific location along a pedestrian route being traversed relative to the indoor area or building. In some embodiments, localization may also include determining a floor within the building, and thus involve determining not only horizontal planar (x, y) coordinates, but also include a vertical, or z, coordinate of the mobile device, the latter embodying a floor number within a multi-floor building, for example. In other embodiments, the (x, y, z) coordinates may be expressed either in a local reference frame specific to the mobile device, or in accordance with a global coordinate reference frame.

The pedestrian area, in embodiments, may be an indoor area within any one of a shopping mall, a warehouse, an airport facility, a hospital facility, a university campus facility or any at least partially enclosed building. The term pedestrian as used herein is intended not encompass not only walking pedestrians, but also users of mobile phones moving at typical pedestrian speeds, for example at less than 10 miles per hour using automated means within the pedestrian area, including but not limited to automated wheelchairs or automated people-moving indoor carts.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

A mobile device as described herein may be implemented, in whole or in part, on mobile computing devices such as cellular or smartphones, laptop computers, wearable computer devices, and tablet devices. Memory, processing, and network resources may all be used in connection with the use and performance of embodiments described herein, including with the performance of any method or with the implementation of any system.

Furthermore, one or more embodiments described herein may be implemented through the use of logic instructions that are executable by one or more processors. These instructions may be carried on a computer-readable medium. In particular, machines shown with embodiments herein include processor(s) and various forms of memory for storing data and instructions. Examples of computer-readable mediums and computer storage mediums include portable memory storage units, and flash memory (such as carried on smartphones). A mobile device as described herein utilizes processors, memory, and logic instructions stored on computer-readable medium. Embodiments described herein may be implemented in the form of computer processor-executable logic instructions or programs stored on computer memory mediums.

### System Description

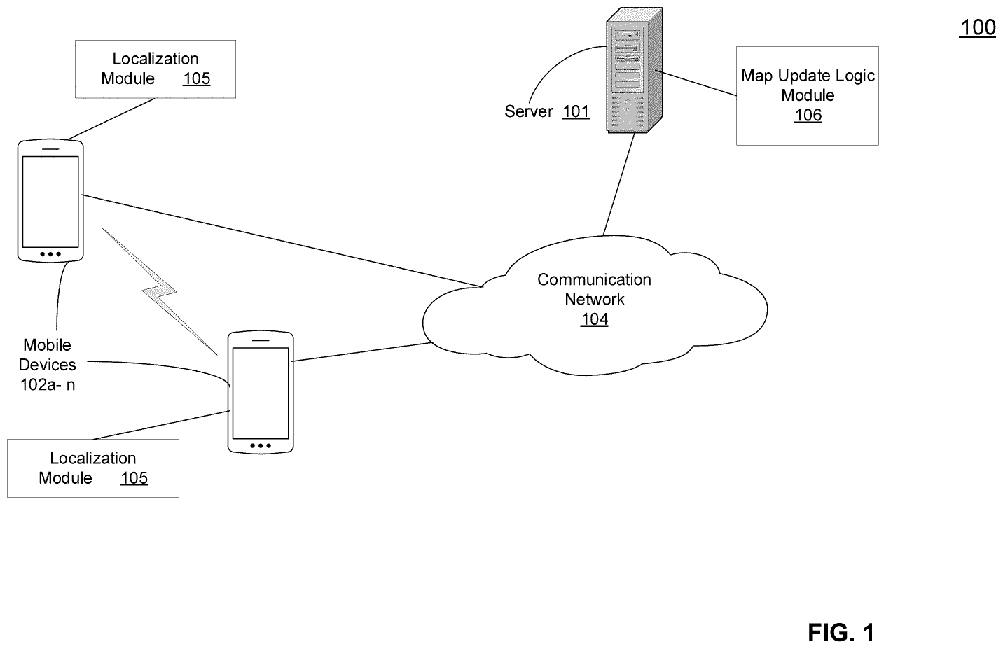

FIG. 1 illustrates, in an example embodiment, a server-based system for crowd-sourced updating of a map feature, such as, but not limited to, a pedestrian area. Mobile devices 102a-n may be such as a cellular or smartphone, a laptop or a tablet computer, or a wearable computer device that may be operational for any one or more of telephony, data communication, and data computing. As used herein, designation as mobile device 102 refers to any representative one of collective mobile devices 102a-n. Mobile device 102 may include fingerprint data of a surrounding or proximate pedestrian area stored in local memory. In other variations, mobile device 102 may be connected within a computer network communication system, including the internet or other wide area network, to remote server computing device 101 that includes map update logic module 106, storing the fingerprint data of the pedestrian area, the latter being communicatively accessible to mobile device 102 for download of the fingerprint data.

A pedestrian navigation, or indoor positioning, software application downloaded and installed, or stored, in a memory of mobile device 102 may render physical layout map of a facility or building of a pedestrian area within a user interface display of mobile device 102. In one embodiment, the pedestrian navigation software application may incorporate one or more portions of processor-executable instructions manifesting localization module 105. The terms localize or localization as used herein refer to determining an estimated coordinate position (x, y, z) along a pedestrian route or trajectory being traversed in accompaniment of mobile device 102. The display of physical layout map may further show a trajectory or pedestrian route traversed by a user in possession of mobile device 102 within the pedestrian area.

Mobile device 102 may include sensor functionality by way of sensor devices. The sensor devices may include inertial sensors such as an accelerometer and a gyroscope, and magnetometer or other magnetic field sensing functionality, barometric or other ambient pressure sensing functionality, humidity sensor, thermometer, and ambient lighting sensors such as to detect ambient lighting intensity. Mobile device 102 may also include capability for detecting and communicatively accessing ambient wireless communication signals including but not limited to any of Bluetooth and Bluetooth Low Energy (BLE), Wi-Fi, RFID, and also satellite-based navigations signals including global positioning system (GPS) signals. Mobile device 102 further includes the capability for detecting, via sensor devices, and measuring a received signal strength, and of determining signal connectivity parameters, related to the ambient wireless signals. In particular, mobile device 102 may include location determination capability such as by way of a GPS module having a GPS receiver, and a communication interface for communicatively coupling to communication network 104, including by sending and receiving cellular data over data and voice channels.

Localization module 105 of mobile device 102 includes instructions stored in memory 202 of mobile device 102, executable in a processor of mobile device 102. In alternate embodiments, it is contemplated that any one or more or portions of localization module 105 may be located at remote server device 101 communicatively accessible to mobile devices 102a-n via network communication interface 207.

A fingerprint data repository, or any portion(s) thereof, may be stored in remote computing server device 101, and made communicatively accessible to mobile device 102 via communication network 104. In some embodiments, it is contemplated that the fingerprint data repository, or any portions of data and processor-executable instructions constituting the fingerprint data repository, may be downloaded for storage, at least temporarily, within a memory of mobile device 102. In embodiments, the fingerprint map data stored in the fingerprint data repository further associates particular positions along pedestrian route of the facility or indoor area with any combination of fingerprint data, including gyroscope data, accelerometer data, wireless signal strength data, wireless connectivity data, magnetic data, barometric data, acoustic data, line-of sight data, and ambient lighting data stored thereon.

The terms fingerprint and fingerprint data as used herein refer to time-correlated, time-stamped individual measurements of any of, or any combination of, received wireless communication signal strength and signal connectivity parameters, magnetic field parameters (strength, direction) or barometric pressure parameters, and mobile device inertial sensor data at known, particular locations along a route being traversed, and also anticipated for traversal, by the mobile device. In other words, a fingerprint as referred to herein may include a correlation of sensor and signal information (including, but not necessarily limited to wireless signal strength, wireless connectivity information, magnetic or barometric information, inertial sensor information and GPS location information) associated for a unique location relative to the facility in accordance with a particular time stamp of gathering the set of mobile sensor data by time correlating the mobile device gyroscope data, the mobile device accelerometer data, mobile device magnetometer data and any other applicable mobile device sensor data, for example. Thus, fingerprint data associated with a particular location or position may provide a fingerprint signature that uniquely correlates to that particular location or position. A sequence of positions or locations that constitute a navigation path traversed by the mobile device relative to a given indoor facility may be fingerprint-mapped during a calibration process, and the resulting fingerprint map stored in a fingerprint data repository of server 101. Server 101 may store respective fingerprint maps of various buildings and indoor areas. The respective building or indoor facility fingerprint maps, or any portions thereof, may be downloaded into a memory of mobile device 102 for use in conjunction with the pedestrian navigation software application executing thereon.

A particular fingerprint or signature based on any of received wireless communication signal strength and signal connectivity parameters, magnetic field parameters or barometric pressure parameters, and mobile device inertial sensor data may be detected or recorded by mobile device 102, whereupon the fingerprint or signature as detected may be matched to a reference fingerprint, or a reference pattern including a set of fingerprints, in a stored fingerprint map of a given facility made accessible to localization module 105 to identify a unique position of mobile device 102 along a pedestrian route. As used herein, term signal connectivity, as distinguished from a signal strength, refers to a wireless radio frequency (RF) signal being available for use in bi-directional data communication, such as between devices that both transmit and receive data using that available wireless RF signal. In some embodiments, given that sampling times and sampling rates applied in conjunction with particular mobile device sensors may be different, the signal and sensor information as measured during the fingerprint calibration process may be time-averaged across particular periods of time, with the time-averaged value being used to represent the signal information at any given instance of time within that particular period of time in which the signal information is time-averaged. Fingerprint data may be used to track traversal of mobile device 102 along a sequence of positions that constitute a pedestrian route within, and even adjoining, the indoor facility.

Localization module 105, constituted of logic instructions executable in a processor of mobile device 102 in one embodiment, may be hosted at mobile device 102 and provides, at least in part, capability for system localizing a mobile device along a pedestrian route traversed in an indoor area. In alternate embodiments, one or more portions constituting localization module 105 may be hosted remotely at a server device and made communicatively accessible to mobile device 102 via communication network 104.

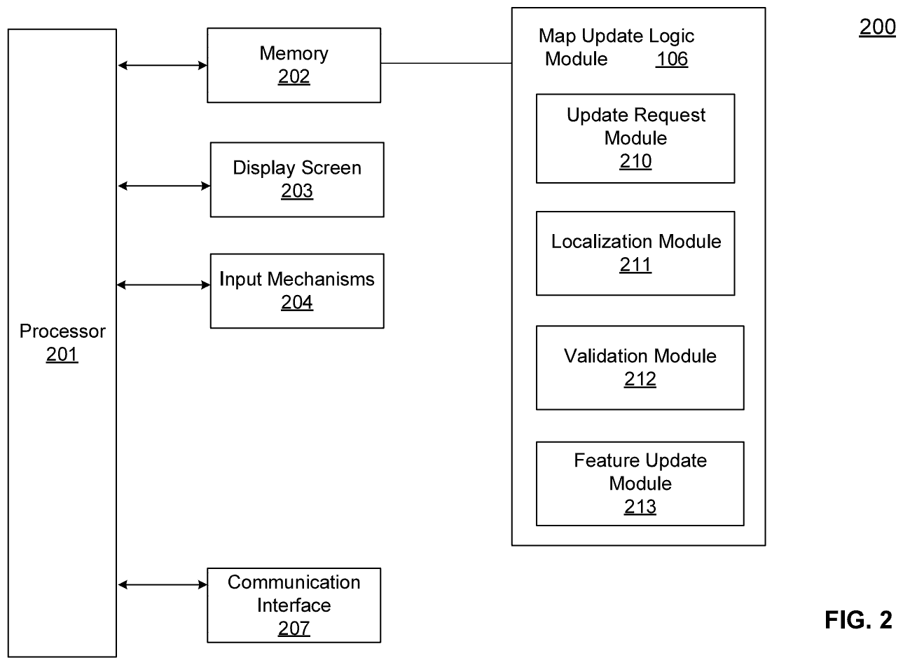

FIG. 2 illustrates, in one example embodiment, an architecture of server computing device 101 in crowd-sourced system 100 for updating a map feature. Server 101, in embodiment architecture 200, may be implemented on one or more server devices, and includes processor 201, memory 202 which may include a read-only memory (ROM) as well as a random access memory (RAM) or other dynamic storage device, display device 203, input mechanisms 204 and communication interface 207 communicatively coupled to communication network 104. Processor 201 is configured with software and/or other logic, including map update logic module 106, to perform one or more processes, steps and other functions described with implementations, such as described by FIGS. 1 through 3 herein. Processor 201 may process information and instructions stored in memory 202, such as provided by a random access memory (RAM) or other dynamic storage device, for storing information and instructions which are executable in processor 201. Memory 202 also may be used for storing temporary variables or other intermediate information during execution of instructions to be executed by processor 201. Memory 202 may also include the ROM or other static storage device for storing static information and instructions for processor 201; a storage device, such as a magnetic disk or optical disk, may be provided for storing information and instructions. Communication interface 207 enables server 101 to communicate with one or more communication networks 104 (e.g., a cellular network) through use of the both wired and wireless network links. Using the network link, server 101 can communicate with mobile computing devices 102a-n.

Processor 201 uses executable instructions of update request module 210 of map update logic module 106 to receive, from mobile device 102, a request for update of a map feature. The map feature, in one embodiment, relates to a landmark, text or image related to an entity within an indoor or pedestrian area.

Processor 201 uses executable instructions stored in localization module 211 to generate a request for localizing mobile device 102. The localizing may comprise location coordinate information and floor number information for the mobile device within a multi-floor building. The request for update may specify at least one of an image and a text name associated with at least one of a business entity and a landmark within the multi-floor building. the localizing is based on at least one of a magnetic field strength and direction, a received wireless communication signal strength, a wireless connectivity indication and a barometric pressure in accordance with fingerprint data of the multi-floor building. The fingerprint data may include respective time-stamps whereby the magnetic field strength and direction, the received wireless signal strength, the wireless connectivity indication and the barometric pressure are time-correlated in accordance with the respective time-stamps.

Processor 201 uses executable instructions stored in validation module 212 to validate the request for update based on a threshold confidence level associated with the localizing. In an embodiment, the localizing comprises a coordinate location having a probabilistic estimate expressed as a confidence level. A confidence level indicative of a degree of accuracy for the localized position of mobile device 102 may be determined, given that the accuracy associated with estimating the position, or location, of a mobile device 102 as a consequence of localization is not absolute, but rather is subject to the statistical, or probabilistic, nature of the fingerprint parameters, including but not limited to the inherently probabilistic nature of wireless radio frequency signal parameters as received. In some embodiments, a degree of accuracy associated with the position estimation may be indicated by a confidence level that is determined for, and assigned in conjunction with, estimated first and second positions as localized. As a measure of the accuracy of localization of mobile device 102, the confidence level associated with the location estimate may be obtained by fusing the probabilistic results of multiple concurrent location estimates. In some embodiments, the variance in the x and y components, with respect to their mean values (μₓ, μᵣ), can be estimated independently as:

$${σ}_{x}^{2} = \frac{1}{N - 1} \sum {( x - {μ}_{x} )}^{2}$$

$${σ}_{y}^{2} = \frac{1}{N - 1} \sum {( y - {μ}_{y} )}^{2}$$

and combined to produce the confidence level. In one embodiment, the overall confidence level can be selected as a function of the maximum standard deviation of the x-y components, as σ=max(σₓ, σ_{y}). In other embodiments, a weighted variance of the x and y, where the weights are based on the probability of each individual estimate can be used to produce the confidence estimate. When multiple trajectory-based location estimates are available, trajectories can be grouped into categories based on similarity and a probability spread/confidence can be assigned on a per-group basis. If the per-group probability/confidence level of one group significantly exceeds that of the other groups, then the confidence in the validity of that group is raised, and hence, the confidence in the location estimate increases. Conversely, if several distinct per-group probabilities are similar, then the confidence in the per-group results are reduced, leading to a lower confidence level. Thus, the estimated position comprises a probabilistic estimate expressed as a confidence level. In one embodiment, the threshold confidence level may be established using a range from 80 percent to 95 percent.

Processor 201 uses executable instructions stored in feature update module 213 to update the map feature in memory 202 of server computing device 101. In one embodiment, the updating may be further based on a threshold number of validated requests for update, and updating the map feature when the validated requests from the first mobile device and the at least a second mobile device exceed the threshold number. In yet another variation, the updating may further include a time-decay based system whereby validated requests that are more recent in time are accorded a higher weighting than any earlier validated requests.

In another embodiment, once updated, the updated map may be deployed, such as by a push update or an update upon request, by server 101 to mobile device 102 and also any other mobile devices 102a . . . n.

### Methodology

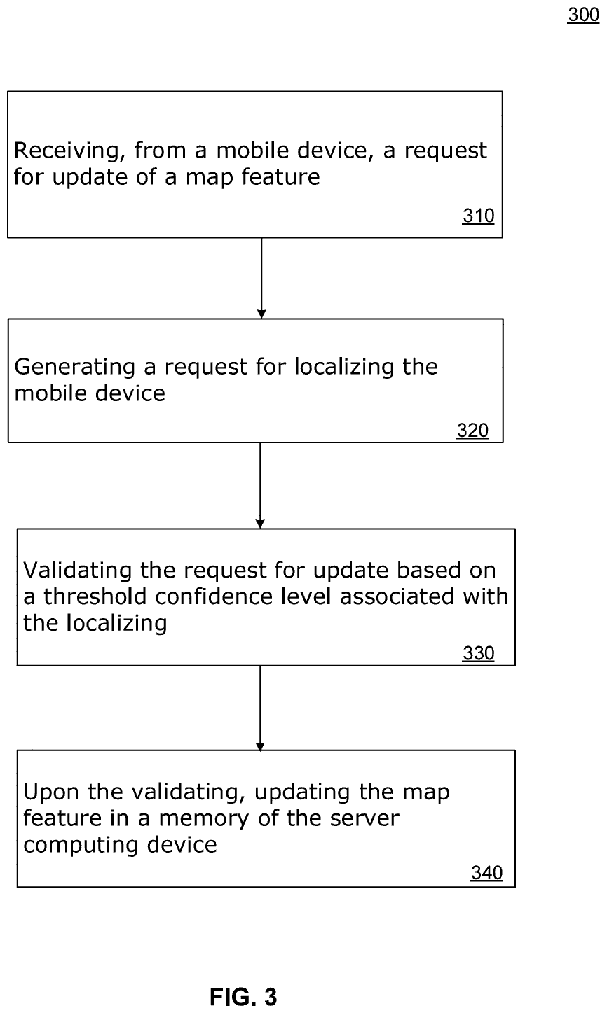

FIG. 3 illustrates an example embodiment of method 300 of updating a map feature within a crowd-sourced map updating system. In describing examples of FIG. 3, reference is made to the examples of FIGS. 1-2 for purposes of illustrating suitable components or elements for performing a step or sub-step being described.

Examples of method steps described herein relate to the use of mobile device 102 in conjunction with server 101 for implementing the techniques described. According to one embodiment, the techniques are performed by map update logic module 106 in response to processor 201 executing one or more sequences of software logic instructions that constitute map update logic module 106 in conjunction with localization module 105 of mobile device 102. In embodiments, localization module 105 may include the one or more sequences of instructions within sub-modules including update request module 210, and localization module 211, and validation module 212. In one embodiment, such instructions may be read into memory 202 of server 101 from machine-readable medium, such as memory storage devices, or downloaded into memory 202 via network communication interface 207. In executing the sequences of instructions of update request module 210, localization module 211, validation module 212 and feature update module 213 of localization module 105 in memory 202, processor 201 performs the process steps described herein. In alternative implementations, at least some hard-wired circuitry may be used in place of, or in combination with, the software logic instructions to implement examples described herein. Thus, the examples described herein are not limited to any particular combination of hardware circuitry and software instructions. Additionally, it is contemplated that in alternative embodiments, the techniques herein, or portions thereof, may be distributed between mobile device 102 in conjunction with communicatively accessible server computing device 101.

At step 310, processor 201 executes instructions included in update request module 210 to receive, from mobile device 102, a request for update of a map feature. The map feature, in one embodiment, relates to a landmark, text or image related to an entity within an indoor or pedestrian area.

At step 320, processor 201 executes instructions included in localization module 211 to generate, using the processor, a request for localizing mobile device 102. The localizing may comprise location coordinate information and floor number information for the mobile device within a multi-floor building. The request for update may specify at least one of an image and a text name associated with at least one of a business entity and a landmark within the multi-floor building. the localizing is based on at least one of a magnetic field strength and direction, a received wireless communication signal strength, a wireless connectivity indication and a barometric pressure in accordance with fingerprint data of the multi-floor building. The fingerprint data may include respective time-stamps whereby the magnetic field strength and direction, the received wireless signal strength, the wireless connectivity indication and the barometric pressure are time-correlated in accordance with the respective time-stamps.

At step 330, processor 201 of server 101 executes instructions included in validation module 212 to validate the request for update based on a threshold confidence level associated with the localizing. In an embodiment, the localizing comprises a coordinate location having a probabilistic estimate expressed as a confidence level. A confidence level indicative of a degree of accuracy for the localized position of mobile device 102 may be determined, given that the accuracy associated with estimating the position, or location, of a mobile device 102 as a consequence of localization is not absolute, but rather is subject to the statistical, or probabilistic, nature of the fingerprint parameters, including but not limited to the inherently probabilistic nature of wireless radio frequency signal parameters as received. In some embodiments, a degree of accuracy associated with the position estimation may be indicated by a confidence level that is determined for, and assigned in conjunction with, estimated first and second positions as localized. As a measure of the accuracy of localization of mobile device 102, the confidence level associated with the location estimate may be obtained by fusing the probabilistic results of multiple concurrent location estimates. In some embodiments, the variance in the x and y components, with respect to their mean values (μₓ, μᵣ), can be estimated independently as:

$${σ}_{x}^{2} = \frac{1}{N - 1} \sum {( x - {μ}_{x} )}^{2}$$

$${σ}_{y}^{2} = \frac{1}{N - 1} \sum {( y - {μ}_{y} )}^{2}$$

and combined to produce the confidence level. In one embodiment, the overall confidence level can be selected as a function of the maximum standard deviation of the x-y components, as σ=max(σₓ, σ_{y}). In other embodiments, a weighted variance of the x and y, where the weights are based on the probability of each individual estimate can be used to produce the confidence estimate. When multiple trajectory-based location estimates are available, trajectories can be grouped into categories based on similarity and a probability spread/confidence can be assigned on a per-group basis. If the per-group probability/confidence level of one group significantly exceeds that of the other groups, then the confidence in the validity of that group is raised, and hence, the confidence in the location estimate increases. Conversely, if several distinct per-group probabilities are similar, then the confidence in the per-group results are reduced, leading to a lower confidence level. Thus, the estimated position comprises a probabilistic estimate expressed as a confidence level. In one embodiment, the threshold confidence level may be established using a range from 80 percent to 95 percent.

At step 340, processor 201 of server 101 executes instructions included in feature update module 213 to update the map feature in memory 202 of server computing device 101. In one embodiment, the updating may be further based on a threshold number of validated requests for update, and updating the map feature when the validated requests from the first mobile device and the at least a second mobile device exceed the threshold number. In yet another variation, the updating may further include a time-decay based system whereby validated requests that are more recent in time are accorded a higher weighting than any earlier validated requests.

In another embodiment, once updated, the updated map may be deployed, such as by a push update or an update upon request, by server 101 to mobile device 102 and also any other mobile devices 102a . . . n.

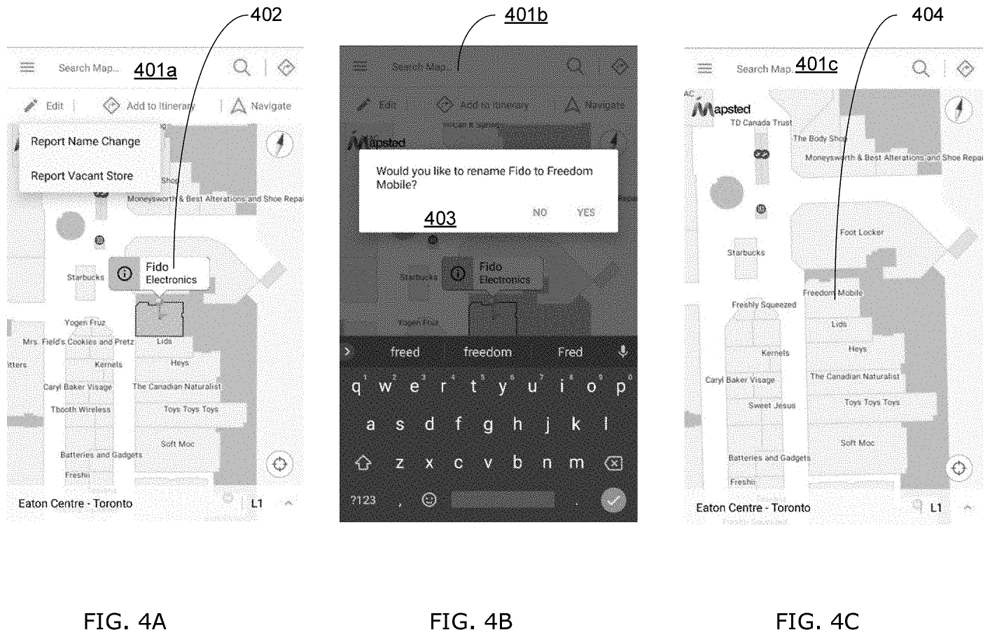

FIGS. 4A-4C illustrate, in an example embodiment, a map feature update performed in conjunction with a user interface display of a mobile device. In describing examples of FIG. 4A-4C, reference is made to the examples of FIGS. 1-3 for purposes of illustrating suitable components or elements for performing a step or sub-step being described.

FIG. 4A illustrates, in an embodiment, graphical user interface display view 401a of mobile device 102, upon which landmark or entity 402 is selected for a requesting a map update by server 101.

FIG. 4B illustrates, in an embodiment, graphical user interface display view 401b of mobile device 102, in which a user of mobile device confirms request 403 for the map update.

FIG. 4C illustrates, in an embodiment, a re-naming map update 404 for the landmark or entity is performed by server 101 and deployed to mobile device 102 in graphical user interface display view 401c of mobile device 102.

In other variations, a user may take a picture of the store sign for the store that requires changing. Using server-side image processing, the store name string is extracted from the image. The extracted store name may compared to the user inputted store name to validate the results. Alternately, the localization of mobile device may provide an accurate indoor location of the user's position when the photo was taken. Cross-validation of the sign name, the user submitted name, and the user location can be performed to ensure that the user is physically in front of the store and that the store name is correct

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no specific mention of the particular combination of features. Thus, the absence of describing combinations should not preclude the inventors from claiming rights to such combinations.

1. A method, executed in a processor of a server computing device, of updating a map feature, the method comprising:
receiving, from a mobile device, a request for update of a map feature of a map of an indoor area, the map feature specifying at least one of an image and a text name associated with an entity in the indoor area, the request relating to an inaccuracy associated with the map feature;
in response to the receiving, generating a request for a location estimate of the mobile device in the indoor area;
receiving the location estimate from the mobile device requesting for update of the map feature;
comparing, using the processor, a location corresponding to the map feature in the map with the location estimate of the mobile device that requests the update;
using the processor, validating the request for update based on a threshold confidence level associated with the location estimate and the based on the comparing, the threshold confidence level being associated with a degree of accuracy of the location estimate of the mobile device; and
when a threshold number of requests for update from a plurality of mobile devices including the mobile device are validated, updating the map feature in a memory of the server computing device.

2. The method of claim 1 wherein the mobile device is a first mobile device, and further comprising deploying the updated map to the first mobile device and at least a second mobile device.

3. (canceled)

4. The method of claim 1 wherein the updating further includes a time-decay based system whereby the validated requests that are more recent in time are accorded a higher weighting than earlier validated requests.

5. The method of claim 1 wherein the localizing comprises location coordinate information and floor number information for the mobile device within a multi-floor building.

6. The method of claim 5 wherein the request for update specifies at least one of the image and the text name associated with at least one of a business entity and a landmark within the multi-floor building.

7. The method of claim 1 wherein the localizing is based on at least one of a magnetic field strength and direction, a received wireless communication signal strength, a wireless connectivity indication and a barometric pressure in accordance with fingerprint data of the multi-floor building.

8. The method of claim 7 wherein the fingerprint data includes respective time-stamps whereby the magnetic field strength and direction, the received wireless signal strength, the wireless connectivity indication and the barometric pressure are time-correlated in accordance with the respective time-stamps.

9. The method of claim 1 wherein the localizing comprises a coordinate location having a probabilistic estimate expressed as a confidence level.

10. The method of claim 9 wherein the threshold confidence level ranges from 80 percent to 95 percent.

11. A server computing device for updating a map feature, the server computing device comprising:
a processor; and
a memory including instructions executable in the processor to:
receive, from a mobile device, a request for update of a map feature of a map of an indoor area, the map feature specifying at least one of an image and a text name associated with an entity in the indoor area, the request relating to an inaccuracy associated with the map feature;
in response to generating a request for a location estimate of the mobile device in the indoor area, receive the location estimate from the mobile device requesting for update of the map feature;
compare a location corresponding to the map feature in the map with the location estimate of the mobile device that requests the update;
validate the request for update based on a threshold confidence level associated with the location estimate and based on the comparing, the threshold confidence level being associated with a degree of accuracy of the location estimate of the mobile device; and
when a threshold number of requests for update from a plurality of mobile devices including the mobile device are validated, update the map feature in the memory of the server computing device.

12. The server computing device of claim 11 wherein the mobile device is a first mobile device, and further comprising deploying the updated map to the first mobile device and at least a second mobile device.

13. (canceled)

14. The server computing device of claim 11 wherein the update of the map feature further includes a time-decay based system whereby the validated requests that are more recent in time are accorded a higher weighting than earlier validated requests.

15. The server computing device of claim 11 wherein the localization comprises location coordinate information and floor number information for the mobile device within a multi-floor building.

16. The server computing device of claim 15 wherein the request for update specifies at least one of the image and the text name associated with at least one of a business entity and a landmark within the multi-floor building.

17. The server computing device of claim 11 wherein the localizing is based on at least one of a magnetic field strength and direction, a received wireless communication signal strength, a wireless connectivity indication and a barometric pressure in accordance with fingerprint data of the multi-floor building.

18. The server computing device of claim 17 wherein the fingerprint data includes respective time-stamps whereby the magnetic field strength and direction, the received wireless signal strength, the wireless connectivity indication and the barometric pressure are time-correlated in accordance with the respective time-stamps.

19. The server computing device of claim 11 wherein the localizing comprises a coordinate location having a probabilistic estimate expressed as a confidence level.

20. The server computing device of claim 19 wherein the threshold confidence level ranges from 80 percent to 95 percent.
